(19) United States
(12) Patent Application Publication
(10) Pub. No.: US 2014/0279636 A1
(43) Pub. Date: Sep. 18, 2014

(54) SYSTEM AND METHOD FOR USING THREE DIMENSIONAL GRAPHICAL FIGURES IN AN ASSESSMENT

(71) Applicant: PROFILES INTERNATIONAL, INC., Waco, TX (US)

(72) Inventors: William L. Bramlett, JR., Tolar, TX (US); Scott Hamilton, China Spring, TX (US)

(73) Assignee: PROFILES INTERNATIONAL, INC., Waco, TX (US)

(21) Appl. No.: 14/204,275

(22) Filed: Mar. 11, 2014

Related U.S. Application Data
(60) Provisional application No. 61/779,662, filed on Mar. 13, 2013.

(51) Int. Cl. G06Q 10/10

(52) U.S. Cl. CPC G06Q 10/1053
USPC 705/321

(57) ABSTRACT

A system maintains a database of scores of job candidates or persons employed in a particular job or occupation. The scores are calculated from responses by the job candidates or the employed persons to inquiries about a display of a three dimensional graphical figure on a true three dimensional display device. The three dimensional graphical figure is displayed on the true three dimensional display device. The display of the three dimensional graphical figure is part of an assessment of a potential job candidate. The system presents an inquiry to the potential job candidate relating to the true three dimensional graphical figure, and receives a response to the inquiry from the potential job candidate. The system calculates a score for the potential job candidate based on the response of the potential job candidate. The system compares the score of the potential job candidate with the scores of the job candidates or the persons employed in a particular job or occupation, and generates the assessment of the potential job candidate based on the comparison.

### RELATED APPLICATIONS

This application claims the benefit of and priority to U.S. Provisional Application No. 61/779,662, filed on Mar. 13, 2013, entitled “System And Method For Using Three Dimensional Graphical Figures In An Assessment,” which is hereby incorporated by reference in its entirety for all purposes. The present disclosure is related to U.S. patent Ser. application Ser. No. 13/107,176, entitled System For Selecting Employment Candidates, which was filed on May 13, 2011, and which is hereby incorporated by reference in its entirety for all purposes.

### TECHNICAL FIELD

The present disclosure relates to a system and method for using in an assessment three dimensional graphical figures that are displayed on a true three dimensional display device, and in an embodiment, but not by way of limitation, using such three dimensional graphical figures in an assessment of an employee or a potential employee.

### BACKGROUND

A business organization that has to select among a pool of candidates to fill job openings is in an unenviable position. Specifically, it is very difficult in the typically rather short evaluation process to identify the candidates that will truly have the best potential for success in a particular job position. Indeed, such employment decisions are normally based only on academic transcripts, a resume, a written recommendation or two, and an in person interview.

Additionally, current systems that attempt to assist in the employee selection process tend to focus only on one definition of a potentially successful candidate. Such systems have difficulty identifying outliers, that is, candidates who are not identified according to the system's standards, but nevertheless would make a potentially successful candidate. Moreover, attempts to broaden the standards or lower the threshold, in an attempt to capture these outliers, seem to identify candidates as potentially successful when they simply are not.

The art is therefore in need of a system that can more accurately and effectively identify persons who would excel in a particular job or a particular occupation.

Additionally, items for an assessment of cognitive ability can contain graphical figures. These figures are used to determine various characteristics of the testee (test-taker) including such things as spacial ability, progressions logic, reasoning, etc. The use of two-dimensional representations of three-dimensional figures limits the range of information that can be obtained with an assessment.

### BRIEF DESCRIPTION OF THE DRAWINGS

FIGS. 1A, 1B, 1C, and 1D are a block diagram illustrating operations and features of a process and system for using three-dimensional graphical figures displayed on a true three-dimensional display device in connection with assessments.

FIGS. 2 and 2A are a flowchart of an example embodiment of a process to identify a candidate for a particular type of job or job opening.

FIGS. 3 and 3A are a flowchart of another example embodiment of a process to identify a candidate for a particular type of job or job opening.

FIG. 4 is an example embodiment of an output of a personal trait model generated by a neural network.

FIGS. 5 and 5A are example embodiments of an output of scores for a candidate.

FIG. 6 is an example embodiment of an output of a particular candidate and scores for that candidate for several types of jobs.

FIG. 7 is an example embodiment of an output comparing a candidate to other candidates.

FIG. 8 is an example embodiment of a computer system upon which one or more embodiments of the present disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Current literature discusses the application of the display of computer-generated true three-dimensional objects in a cognitive evaluation. However, such cognitive evaluation is limited to diagnosis and/or therapy for severe brain injury or dementia.

A method is needed to present three-dimensional figures in three dimensions in a computer-presented assessment featuring a true three-dimensional computer monitor. The present disclosure discusses the use of such three-dimensional figures in a cognitive assessment. Specifically, the use of true three-dimensional graphical figures in the present disclosure is related to cognitive assessment in the workplace and predicting the likelihood of success of a specific individual for a given job, career, or occupation. Successful incumbents in a job are assessed, and their cognitive measure is compared to a candidate in order to determine the candidate's match for the respective job.

By way of background, the representation of a three-dimensional figure in only two dimensions limits the clarity and thus possible complexity in the figures that are available for use in an assessment. The additional clarity of three dimensions allows greater complexity in the figures, and extends the utility of the assessment for measuring the capability of the subject. In general, test-takers have become more competent in using computers, keyboards, and pointing devices, and also in understanding graphic representations on the computer. The addition of true three-dimensional figures greatly enhances the effectiveness of an assessment. The scoring of the test-taker's responses may be in the form of a multiple choice selection, the time spent in making a selection, and/or tracking the movements made by the test-taker while arriving at a solution.

A graphical figure is presented in three dimensions on an appropriate three-dimensional monitor, that is, a true three-dimensional monitor. The level of complexity of such a true three-dimensional graphical figure can vary with the difficulty level of the question. The test-taker selects his or her answer from a presentation of possible answers that are also presented to the test-taker on the true three-dimensional monitor. The test-taker can use a mouse or other input device to manipulate the displayed graphical figure and/or the figures provided in the possible answers.

In another embodiment, the three-dimensional representation of the graphical figure can be manipulated by the test-taker. This permits the test-taker to clarify the details of the representation of the graphical figure that is displayed on the true three-dimensional monitor. After manipulation by the test-taker, he or she answers questions about the details of the three-dimensional graphical figure relating to the content of the graphical figure, the sizes of the voids in the graphical figure, the number of specific situations in the figure (e.g., determining the differences between two similar figures), and the organization of the figure.

In another embodiment, a series of building “blocks” are provided to the test-taker. The test-taker can then be asked to replicate a provided three-dimensional graphical figure, build a mirror image of the provided three-dimensional graphical figure, identify the number of steps needed to build a specific graphical figure, the order of steps that are needed to build a specific graphical figure, and/or which of the available building blocks are needed to build a specific graphical figure.

FIGS. 1A, 1B, 1C, and 1D are a flowchart-like diagram of features and steps of an example system and process 100 for an assessment of a person in an employment or career context using true three-dimensional graphical figures. FIGS. 1A, 1B, 1C, and 1D include a number of process blocks 105-195. Though arranged substantially serially in the example of FIGS. 1A, 1B, 1C, and 1D, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 1A, 1B, 1C, and 1D, at 105, a database of scores of job candidates and/or persons employed in a particular job, career, or occupation is maintained in a database in a computer storage device. The scores are calculated from responses by the job candidates or the employed persons to inquiries about a display of one or more three dimensional graphical figures on a true three dimensional display device.

At 110, one or more of the same graphical figures that are stored in the database are displayed on a true three dimensional display device. The display of the three dimensional graphical figures is in connection with an assessment of a potential job candidate. At 115, an inquiry relating to the true three dimensional graphical figure is presented to the potential job candidate. At 120, the system receives a response to the inquiry from the potential job candidate. At 125, a score is calculated for the potential job candidate based on the response of the potential job candidate. At 130, the score of the potential job candidate is compared to the scores of other job candidates or the persons employed in a particular job or occupation. At 135, an assessment of the potential job candidate is generated based on the comparison.

The inquiry to the potential job candidate includes several features. At 140, the inquiry includes a presentation to the potential job candidate of a plurality of choices relating to the displayed three dimensional graphical figure. The plurality of choices relates to different views of the displayed three dimensional graphical figure. At 141, the system receives from the potential job candidate a manipulation of the displayed three dimensional graphical figure or a manipulation of views of the plurality of choices. At 142, the system receives from the potential job candidate a selection of one of the plurality of choices. In an embodiment, the selected three-dimensional graphical figure relates in some way to the displayed three-dimensional graphical figure. For example, the system can inquire of the potential job candidate which of the choices is exactly the same as the displayed three-dimensional graphical figure, which of the choices is the most similar to the displayed three dimensional graphical figure, and/or which of the choices is most dissimilar to the displayed three dimensional graphical figure.

At 145, the inquiry relates to one or more of the content of the displayed three dimensional graphical figure, the size of voids in the three dimensional graphical figure, the number of specific situations relating to the displayed three dimensional graphical figure, and an organization of the three dimensional graphical figure. As noted above, and as indicated at 146, the specific situations and organization of the three dimensional graphical figure can relate to identifying the differences between two similar three dimensional graphical figures.

At 150, the assessment system displays a plurality of building blocks. At 151, after the display of the building blocks, the inquiry includes requesting that the potential job candidate construct the displayed three dimensional graphical figure using the plurality of building blocks. Similarly, at 152, after the display of the plurality of building blocks, the inquiry includes requesting the potential job candidate to construct a mirror image of the displayed three dimensional graphical figure. Additionally, at 153, after the display of the plurality of building blocks, the inquiry includes requesting the potential job candidate to identify one or more steps needed to construct the displayed three dimensional graphical figure from the plurality of building blocks, identify an order of the steps needed to construct the displayed three dimensional graphical figure from the plurality of building blocks, and/or identify which of the plurality of building blocks are necessary to construct the displayed three dimensional graphical figure.

At 155, the assessment system calculates the score for the potential job candidate based on the response from the potential job candidate as a function of one or more of an amount of time used by the potential job candidate in providing the response and manipulations to the displayed three dimensional graphical figure made by the potential job candidate when providing the response.

At 160, the assessment system determines a portion of the persons in a particular job or occupation that make up the top performers in the occupation. At 161, the assessment system determines a portion of the persons in a particular job or occupation that make up the bottom performers in the occupation. Thereafter, at 162, the scores of the persons in the particular job or occupation are input into a software-based neural network. At 163, the assessment system uses the neural network to generate models for each inquiry or for a group of inquiries as a function of the scores of the top performers for each inquiry or group of inquiries. At 164, the assessment system uses the neural network to generate a performance model that includes the models for each inquiry or group of inquiries. At 165, the performance model is used to determine whether the potential job candidate will likely be a top performer in the particular job or occupation, a bottom performer in the particular job or occupation, or neither a top performer or a bottom performer. At 166, the system uses the performance model to identify the potential job candidate as a potential top performer or a potential bottom performer in the particular job or occupation.

At 170, the assessment system receives scores for the potential job candidate. The scores relate to a plurality of inquiries that were made to the potential job candidate. At 171, the scores for the potential job candidate are compared to the performance model. At 172, an assessment of whether the potential job candidate is likely to be rated as a top performer, a bottom performer, or neither a top performer nor a bottom performer is generated. At 173, the scores relating to the potential job candidate and the scores used to generate the performance model are obtained from the responses provided by the potential job candidate and the responses of the persons employed in a particular job or occupation to the display of the same three dimensional graphical figures.

At 174, a second display is generated on an output device. The second display includes data relating to the assessment of the potential job candidate. At 175, the second display includes one or more of a ranking relating to the potential job candidate, the other job candidates, and the persons employed in the particular job or occupation.

At 180, the models are made up of a numeric range. Additionally, the neural network generates at least one model comprising two or more sub-ranges within the numeric range of the at least one model such that the system is less likely to treat the potential job candidate as an outlier candidate. At 181, the neural network is used to determine a breadth of a particular model. At 182, the neural network is used to determine a weight to be accorded to a particular model. At 183, the neural network is used to generate a plurality of performance models. Each of the generated plurality of performance models can be used to identify the potential job candidate as a potential top performer. At 184, the neural network is used to null out a particular model and to determine the effect of the nulling out on other models.

At 185, the assessment system is used to generate a hiring recommendation for the potential job candidate. The hiring recommendation can include a recommendation to hire the individual, a recommendation to not hire the individual, or a recommendation to further consider the individual via additional interviews, further testing, or other means.

At 190, the scores calculated from responses by the job candidates or the employed persons are further in response to inquiries relating to behavioral traits and interest traits. At 191, the inquiry presented to the potential job candidate further relates to the behavioral traits and the interest traits. At 192, the score for the potential job candidate is further based on the response of the potential job candidate to the inquiry relating to the behavioral traits and the interest traits. The operations 190, 191 and 192 permit a full assessment of an individual in the areas of cognitive traits (via the true three dimensional shapes) and behavioral and interest traits (via traditional questions relating to the individual's behaviors and interests).

At 195, the display of the three dimensional graphical figure on the true three dimensional display device permits an assessment of one or more of the job candidates, the persons employed in a particular job or occupation, and the potential job candidate when a primary language of one or more of the job candidates, the persons employed in a particular job or occupation, and the potential job candidate is not the same as the primary language of the system. This feature permits the system to overcome language barrier issues when assessing persons.

Regarding biological neural networks more particularly, biological neural networks are made up of neurons that are connected or functionally related in the peripheral nervous system or the central nervous system. In the field of neuroscience, neural networks are often identified as groups of neurons that perform a specific physiological function.

Artificial neural networks are made up of interconnecting artificial neurons, that is, programming constructs that mimic the properties of biological neurons. Artificial neural networks can be used to gain an understanding of biological neural networks, or for solving artificial intelligence problems without necessarily creating a model of a real biological system. The tasks to which artificial neural networks are applied tend to fall into the following categories. A first category includes function approximation, or regression analysis, including time series predicting and modeling. A second category includes classification, including pattern and sequence recognition, novelty detection, and sequential decision making. A third category includes data processing, including filtering, clustering, and blind signal separation and compression. The third category can further include system identification and control (vehicle control, process control), pattern recognition (radar systems, face identification, and object identification), sequence recognition (gesture, speech, handwritten text), medical diagnoses, financial applications, data mining, visualization, email spam filtering, and game playing and decision making.

An artificial neural network is trained to recognize multiple patterns that may be desirable, and distinguish these desirable patterns from other patterns that are not desirable. It is this technique of artificial neural networks that can be applied to one or more embodiments that identify a potentially successful candidate for a particular profession. Such artificial neural networks can be obtained from software companies that specialize in the design and implementation of such neural networks. Such companies normally can design and construct a customized neural network based on the needs of a particular customer, or modify and adapt a basic neural network to the needs of such a customer. For example, two such neural network providers are NeuralWare of Carnegie, Pa., and StatSoft of Tulsa, Okla.

FIGS. 2, 2A, 3, and 3A are flowcharts of example processes 200 and 300 for using a neural network to select employees for a particular job or occupation. The processes 200 and 300 can identify the candidates who are most likely to be the top performers in a particular job or occupation. This identification is accomplished by using the neural network to model the personal and performance traits of known top performers in the occupation, and comparing a candidate for a job or occupation to the model. FIGS. 2, 2A, 3, and 3A include a number of process blocks 205-280 and 305-390 respectively. Though arranged serially in the example of FIGS. 2, 2A, 3, and 3A, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 2 and 2A, the process 200 includes at 205 receiving into a computer processor data relating to a plurality of persons. The persons are employed in the same occupation. A portion of the persons includes top performers in the occupation, and a portion of the persons includes bottom performers in the occupation. The data relates to one or more of personal traits and performance traits. Personal traits can relate to such areas as cognitive traits, behavioral traits, and interests (270). More specifically, the personal traits can relate to such measures as a person's energy level, assertiveness, sociability, manageability, attitude, decisiveness, accommodating character, independence, and objective judgment (275). Performance traits can relate to such things as a sales quota, an error rate, a production level, and customer complaints involving the person (280).

At 210, the data relating to the plurality of persons are input into a software-based neural network. At 215, the neural network generates models for the personal traits as a function of the personal traits and the performance traits of the top performers. An example of such a model 400 for the personal trait of decisiveness is illustrated in FIG. 4. Specifically, the neural network derives the model 400, based on the personal traits and performance traits of the plurality of persons, and in particular the top performers of the plurality of persons, by analyzing responses to questions relating to decisiveness from the top performers. As can be seen in FIG. 4, the neural network has identified that top performers in the pertinent occupation range from a score of 4 to 7 for the personal trait of decisiveness. That is, the model for decisiveness is the 4-7 range.

At 220, the neural network generates a performance model. The performance model is made up of a number of models for the personal traits. An example of a performance model 500 is illustrated in FIG. 5. As can be seen in FIG. 5, the performance model 500 includes nine personal trait models 535 - - - energy level, assertiveness, sociability, manageability, attitude, decisiveness, accommodating character, independence, and objective judgment. Each personal trait model is identified by a particular range, such as the energy level model is identified by the range of 5-7, as indicated by the right leaning slash marks over those range numbers. In this manner, at 225, the neural network configures the performance model to determine whether a particular person, who is not currently in a particular job or a particular occupation, will likely be a top performer in that particular occupation, a bottom performer in that particular occupation, or neither a top performer or a bottom performer in that particular occupation.

At 230, data relating to the particular person who is not currently in a particular job or occupation is received. This data relates to the personal traits of that particular person. At 235, the data relating to the particular person is compared to the performance model 500. At 240, an assessment is generated relating to whether the particular person is likely to be rated as a top performer, a bottom performer, or neither a top performer nor a bottom performer.

At 245, the data relating to the particular person and the data relating to the plurality of persons are obtained from answers provided by the particular person and the plurality of persons to a set of questions related to the personal traits of the particular person and the plurality of persons. In an embodiment, these questions are independent of the models, the performance model, and the occupation. At 250, a display that includes data relating to the assessment of the particular person is generated on an output device. These displays include many different forms.

For example, the display can be the performance model 500, and the performance model can indicate how, for each personal trait, the particular person compares to the models generated by the neural network (using the personal trait data of the top performers in the pertinent occupation). The performance model 500 in FIG. 5 further shows that for this particular person, Charlie Smith, his overall job match 505 for the occupation of a bank teller is 82%. That is, there is an 82% chance that Charlie Smith will be a top performer or successful candidate as a bank teller. In an embodiment, this job match percentage is determined by calculating the percentage of personal trait character model ranges into which the candidate falls. In another embodiment, different portions of the range such as lower, middle, or upper are weighted more heavily than other portions of the model range. Similarly, Mr. Smith's thinking style 510, behavioral traits 515, and interests 520 fall into the models generated using the personal traits of the top performers 88%, 83%, and 68% of the time respectively. FIG. 5 further illustrates Mr. Smith's match versus other candidates in the bar graph at 525. As the bar graph 525 shows, this candidate's job match was 82% as compared with matching percentages of other candidates. The bar graph 525 further shows that the most common job match percentage for this example was 76%. FIG. 5 further illustrates how a particular person compares with each of the personal trait models 535, generated by the neural network using the personal trait data of the top and bottom performers. For example, in FIG. 5, Mr. Smith fell outside the range for energy level, sociability, attitude, decisiveness, and accommodating character, as indicated by the left leaning slashes in the pertinent boxes within each model (4 for energy level, 4 for sociability, 2 for attitude, 3 for decisiveness, and 2 for accommodating character). FIG. 5 further illustrates that Mr. Smith fell within the range for assertiveness, manageability, accommodating character, independence, and objective judgment, as indicated by the cross-hatched lines in the pertinent boxes within each model (3 for assertiveness, 4 for manageability, 7 for independence, and 3 for objective judgment). The displayed output can further indicate a particular person's rankings related to a plurality of occupations as illustrated in FIG. 6, and a comparison of several different persons regarding job match percentages, cognitive traits, interests, and behavioral traits for a particular occupation, such as a bank teller as illustrated in FIG. 7.

As further indicated in the performance model of FIG. 5, the neural network generates a range relating to a particular personal trait, such as from 1-10 for the personal traits 535 in FIG. 5. Then, based upon the personal trait data relating to the top performers, the neural network generates a sub-range within this range. The sub-range serves as the actual model. As noted in this example, the sub-range and the range are a numeric scale. In another embodiment, as indicated at 255, the neural network can determine the breadth of a particular model. In FIG. 5, the neural network has determined that the breadth of the assertiveness personal trait is three, while the breadth of the independence personal trait is four. Similarly, at 260, the neural network can assign a weight to be applied to each of the personal traits in the model. Once again, the neural network determines the breadth of each personal trait model and the weight to assign to each personal trait model based on the data of the bottom and top performers for this occupation.

At 260, the neural network generates a plurality of performance models. These performance models include one or more different traits models for the models that make up the performance models. The plurality of performance models makes it less likely that an outlier candidate will be missed. For example, FIG. 5A illustrates another performance model 550. The performance model 550 was generated by the neural network using the data relating to the top and bottom performers, just like the performance model 500 of FIG. 5 was generated. The neural network determined that the data for the top and bottom performers indicate that top bank tellers display an assertiveness ranking of 3-5 and 7-9, and an independence ranking of 1-3 and 6-9. Consequently, the neural network generated a performance model 500 to identify potential top bank tellers, wherein the assertiveness and independence rankings are 3-5 and 6-9 respectively, and a performance model 550 to identify top bank tellers, wherein the assertiveness and independence rankings are 7-9 and 1-3 respectively. In another embodiment, instead of generating two separate (but related) performance models as illustrated in FIGS. 5 and 5A, the different rankings or ranges for a particular personal trait could be part of the particular personal trait model of a single performance model.

It is noted that the use of different sub-ranges or rankings for a particular trait among two or more performance models to identify outlier candidates is not just simply permitting a different range or ranking to be acceptable (for a particular personal trait). That is, it is not just permitting two or more ranges of a particular trait to be present in a single performance model. Rather, the different ranges for the particular trait should be in separate performance models since a first range of a trait may only have legitimacy in association with particular ranges of other traits, and a second range of that same trait may only have legitimacy in association with different particular ranges of other traits. By tying the two ranges of the trait to one or more other personal traits, there is a relatively narrow area on each model that establishes a “sweet spot” for an outlier candidate. That is, the selectivity of the system can be enhanced by establishing another model that is focused on a completely different set of criteria giving an equally strong candidate for a particular job or employment position. These ties or associations of traits are determined by the neural network. In some circumstances at least, if the multiple rankings were in the same performance model, such a system could actually reduce the selectivity and effectiveness of the system. Stated another way, a different ranking, range, or score on a personal trait model that may include an outlier should be associated with the ranges of other personal trait models in each performance model (as indicated above in connection with the assertiveness and independence traits). For example, for a particular occupation, the neural network may determine that a person can be successful if they are either independent (6-9) or not independent (1-3). However, such independent models are only legitimate when they are correctly correlated with the particular other trait models of the particular performance model. That is, for example, a particular range for assertiveness must hold true for the independent model of (6-9), and a different range for assertiveness must hold true for the other independent range of (1-3). Consequently, two or more performance models are best used. As noted above, by generating multiple performance models for the different independence ranges, it is less likely that outlier candidates will be missed. If the system was limited to only one of the ranges for the particular trait, candidates who fall into the other independence range would be missed (even though the neural network would indicate that a particular performance model generated with that range could identify potential successful candidates).

At 265, the neural network nulls out a particular model and determines the effect of the nulling out on other models, the performance model, and the selection of potential candidates.

FIGS. 3 and 3A illustrates another example embodiment of a process 300 that uses a neural network to select employees for a particular job or occupation. At 305, data is received relating to personal traits and occupational performance traits of a plurality of persons who are employed in the same occupation. At 310, the persons are divided into two groups. The two groups are made up of a first group of top performers in the occupation and a second group of bottom performers in the occupation. The division into the two groups is based on the occupational performance traits of the plurality of persons. At 315, the data relating to the personal traits and the occupational performance traits of the two groups are input into a software-based neural network. At 320, the neural network generates models for the personal traits as a function of the personal traits and the performance traits of the two groups, and at 330, the neural network generates a performance model comprising the models. At 333, it is noted that the data relating to the personal traits of the two groups are derived from a set of questions. The set of questions is independent of the models, the performance model, and the occupation. In an embodiment, the set of questions is developed by an industrial psychologist, and in another embodiment the questions are developed before the generation of any models and/or performance models.

After the generation of the performance model, the following steps are executed. At 335, data are collected from a particular person using the set of questions. At 340, the data from the particular person are input into the performance model, and at 345, the performance model identifies the particular person as a potential top performer or a potential bottom performer in the occupation.

At 350, it is noted that the particular person is not one of the plurality of persons. At 352, the plurality of persons and the particular person are employed by a business organization, at 354, the plurality of persons is employed by a business organization and the particular person is not employed by the business organization, and at 356, the business organization is a single business organization.

At 358, a display is generated on an output device. The display includes data relating to the assessment of the particular person. The display can include a ranking relating to the particular person and the occupation, a ranking relating to the particular person and cognitive traits for the occupation, a ranking relating to the particular person and interests for the occupation, and a ranking relating to the particular person and behavioral traits for the occupation.

At 360, the models for the personal traits comprise a sub-range within a range, and the sub-range and the range comprise a numeric scale. At 365, the neural network determines a breadth of a particular model, and the neural network determines a weight to be accorded to a particular model.

At 370, the neural network generates a plurality of performance models. In this plurality of performance models, each performance model is configured to identify the particular person as a potential top performer. As noted above, a plurality of performance models can be used to assist in capturing any outliers in the group. At 375, the neural network nulls out a particular model. The neural network can then determine the effect the nulling out of the particular model has on the other models, the performance model, and the selection of a particular candidate. At 380, the performance traits include a sales quota, an error rate, a production level, and/or a level of customer complaints. At 385, the personal traits include cognitive traits, behavioral traits, and/or interests. At 390, the personal traits include energy level, assertiveness, sociability, manageability, attitude, decisiveness, accommodating character, independence, and objective judgment.

FIG. 8 is an overview diagram of hardware and an operating environment in conjunction with which embodiments of the invention may be practiced. The description of FIG. 8 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 8, a hardware and operating environment is provided that is applicable to any of the servers and/or remote clients shown in the other Figures.

As shown in FIG. 8, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 8 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1-23. (canceled)

24. A system comprising:
a computer processor and computer storage device configured to:
maintain in the computer storage device a database of scores of job candidates or persons employed in a particular job or occupation, the scores calculated from responses by the job candidates or the employed persons to inquiries about a display of a three dimensional graphical figure on a true three dimensional display device;
display the three dimensional graphical figure on the true three dimensional display device, the display of the three dimensional graphical figure comprising an assessment of a potential job candidate;
present an inquiry to the potential job candidate relating to the display of the three dimensional graphical figure on the true three dimensional display device;
receive a response to the inquiry from the potential job candidate;
calculate a score for the potential job candidate based on the response of the potential job candidate;
compare the score of the potential job candidate with the scores of the job candidates or the persons employed in the particular job or occupation; and
generate the assessment of the potential job candidate based on the comparison.

25. The system of claim 24, wherein the inquiry to the potential job candidate comprises:
a presentation to the potential job candidate of a plurality of choices relating to the three dimensional graphical figure displayed on the true three dimensional display device, the plurality of choices relating to different views of the three dimensional graphical figure displayed on the true three dimensional display device;
a reception from the potential job candidate of a manipulation of the three dimensional graphical figure displayed on the true three dimensional display device or a manipulation of views of the plurality of choices; and
a reception of a selection of one of the plurality of choices by the potential job candidate.

26. The system of claim 24, wherein the inquiry relates to one or more of content of the three dimensional graphical figure displayed on the true three dimensional display device, a size of a void in the three dimensional graphical figure displayed on the true three dimensional display device, a number of specific situations relating to the three dimensional graphical figure displayed on the true three dimensional display device, and an organization of the three dimensional graphical figure displayed on the true three dimensional display device.

27. The system of claim 26, wherein the number of specific situations comprises a determination by the potential job candidate of differences between two or more similar three dimensional graphical figures displayed on the true three dimensional display device.

28. The system of claim 24, wherein the computer processor is operable to display a plurality of building blocks; and wherein the inquiry comprises requesting the potential job candidate to construct the three dimensional graphical figure displayed on the true three dimensional display device using the plurality of building blocks.

29. The system of claim 24, wherein the computer processor is operable to display a plurality of building blocks; and wherein the inquiry comprises requesting the potential job candidate to construct a mirror image of the three dimensional graphical figure displayed on the true three dimensional display device.

30. The system of claim 24, wherein the computer processor is operable to display a plurality of building blocks; and wherein the inquiry comprises requesting the potential job candidate to identify one or more steps needed to construct the three dimensional graphical figure displayed on the true three dimensional display device from the plurality of building blocks, identify an order of the steps needed to construct the three dimensional graphical figure displayed on the true three dimensional display device from the plurality of building blocks, or identify which of the plurality of building blocks are necessary to construct the three dimensional graphical figure displayed on the true three dimensional display device.

31. The system of claim 24, wherein the calculation of the score for the potential job candidate based on the response from the potential job candidate is a function of one or more of an amount of time used by the potential job candidate in providing the response, and an amount of manipulations and type of manipulations made by the potential job candidate to the three dimensional graphical figure displayed on the true three dimensional display device when providing the response.

32. The system of claim 24, wherein a portion of the persons in a particular job or occupation comprise top performers in the occupation, and a portion of the persons in a particular job or occupation comprise bottom performers in the occupation.

33. The system of claim 32, wherein the scores of the persons in the particular job or occupation are input into a software-based neural network, and the computer processor is operable to use the neural network to generate models for each inquiry or for a group of inquiries as a function of the scores of the top performers for each inquiry or group of inquiries; and to use the neural network to generate a performance model comprising the models for each inquiry or group of inquiries; wherein the performance model is configured to determine that the potential job candidate will likely be a top performer in the particular job or occupation, a bottom performer in the particular job or occupation, or neither a top performer nor a bottom performer in the particular job or occupation.

34. The system of claim 33, comprising using the performance model to identify the potential job candidate as a potential top performer or a potential bottom performer in the particular job or occupation.

35. The system of claim 34, wherein the computer processor is operable to:
receive scores for the potential job candidate, the scores relating to a plurality of inquiries;
compare the scores for the potential job candidate to the performance model; and
generate an assessment of whether the potential job candidate is likely to be rated as a top performer, a bottom performer, or neither a top performer nor a bottom performer.

36. The system of claim 35, wherein scores relating to the potential job candidate and the scores used to generate the performance model are obtained from the responses provided by the potential job candidate and the responses of the persons employed in a particular job or occupation to the display of the same three dimensional graphical figures displayed on the true three dimensional display device.

37. The system of claim 34, comprising one or more computer processors operable to generate a second display on an output device, the second display including data relating to the assessment of the potential job candidate.

38. The system of claim 37, wherein the second display comprises one or more of a ranking relating to the potential job candidate, the other job candidates, and the persons employed in the particular job or occupation.

39. The system of claim 33, wherein the models comprise a numeric range, and wherein the neural network generates at least one model comprising two or more sub-ranges within the numeric range of the at least one model such that the system is less likely to treat the potential job candidate as an outlier candidate.

40. The system of claim 33, comprising using the neural network to determine a breadth of a particular model.

41. The system of claim 33, comprising using the neural network to determine a weight to be accorded to a particular model.

42. The system of claim 33, comprising using the neural network to generate a plurality of performance models, each performance model configured to identify the potential job candidate as a potential top performer.

43. The system of claim 33, comprising using the neural network to null out a particular model and to determine the effect of the nulling out on other models.

44. The system of claim 24, wherein the assessment comprises a hiring recommendation.

45. The system of claim 24,
wherein the scores calculated from responses by the job candidates or the employed persons are further in response to inquiries relating to behavioral traits and interest traits;
wherein the inquiry presented to the potential job candidate further relates to the behavioral traits and the interest traits; and
wherein the score for the potential job candidate is further based on the response of the potential job candidate to the inquiry relating to the behavioral traits and the interest traits.

46. The system of claim 24, wherein the display of the three dimensional graphical figure on the true three dimensional display device permits an assessment of one or more of the job candidates, the persons employed in a particular job or occupation, and the potential job candidate, when a primary language of one or more of the job candidates, the persons employed in a particular job or occupation, and the potential job candidate is not the same as the primary language of the system.

47. A process comprising:
maintaining in a computer storage device a database of scores of job candidates or persons employed in a particular job or occupation, the scores calculated from responses by the job candidates or the employed persons to inquiries about a display of a three dimensional graphical figure on a true three dimensional display device;
displaying the three dimensional graphical figure on the true three dimensional display device, the display of the three dimensional graphical figure on a true three dimensional display device comprising an assessment of a potential job candidate;
presenting an inquiry to the potential job candidate relating to the display of the three dimensional graphical figure on the true three dimensional display device;
receiving a response to the inquiry from the potential job candidate;
calculating a score for the potential job candidate based on the response of the potential job candidate;
comparing the score of the potential job candidate with the scores of the job candidates or the persons employed in the particular job or occupation; and
generating the assessment of the potential job candidate based on the comparison.

48. A computer readable storage device comprising instructions that when executed by a processor executes a process comprising:
maintaining in a computer storage device a database of scores of job candidates or persons employed in a particular job or occupation, the scores calculated from responses by the job candidates or the employed persons to inquiries about a display of a three dimensional graphical figure on a true three dimensional display device;
displaying the three dimensional graphical figure on the true three dimensional display device, the display of the three dimensional graphical figure on a true three dimensional display device comprising an assessment of a potential job candidate;
presenting an inquiry to the potential job candidate relating to the display of the three dimensional graphical figure on the true three dimensional display device;
receiving a response to the inquiry from the potential job candidate;
calculating a score for the potential job candidate based on the response of the potential job candidate;
comparing the score of the potential job candidate with the scores of the job candidates or the persons employed in the particular job or occupation; and
generating the assessment of the potential job candidate based on the comparison.
